(19) United States
(12) Patent Application Publication
(10) Pub. No.: US 2015/0100952 A1
(43) Pub. Date: Apr. 9, 2015

(54) Runtime Version Access Infrastructure

(71) Applicants: Dominik Tornow, Palo Alto, CA (US); Joerg Latza, Walldorf (DE)

(72) Inventors: Dominik Tornow, Palo Alto, CA (US); Joerg Latza, Walldorf (DE)

(73) Assignee: SAP AG, Walldorf (DE)

(21) Appl. No.: 14/049,791

(22) Filed: Oct. 9, 2013

(51) Int. Cl. G06F 9/44

(52) U.S. Cl. CPC G06F 8/71
USPC 717/170

(57) ABSTRACT

In one embodiment the present disclosure includes a runtime access component that receives requests specifying a particular version of a particular runtime program to be executed. The requests are converted and sent to destinations capable of executing the specified version of the runtime program. In one embodiment, a received request includes an address with version and runtime information. The version and runtime information are mapped to a destination address that is sent to execute the specified runtime version. In another embodiment, a version control system deploys executable code before the runtime version is executed.

### BACKGROUND

The present disclosure relates to a runtime version access infrastructure, and in particular, to a runtime version access infrastructure that provides access to multiple versions and configurations of an application runtime.

Unless otherwise indicated herein, the approaches described in this section are not prior art to the claims in this application and are not admitted to be prior art by inclusion in this section.

A typical user may not be allowed to access old versions of an application runtime once a new version has been deployed. Even though a version control system may retain and track previous versions and configurations of an application runtime, the version control system does not commonly make available any of the previous versions. Version control systems typically ignore previous versions when a request is made to access a particular application runtime. An example of such a version control system is Git, which is a version control and source code management system. Thus users are forced to use the most recent version and configuration of a runtime, regardless of the user need. Such limited access may remove desirable application runtime versions and configurations from use, or hinder the functioning of a necessary long-running application.

### SUMMARY

In one example embodiment the present disclosure includes a runtime access component that receives requests specifying a particular version of a particular runtime program to be executed. The requests are converted and sent to destinations capable of executing the specified version of the runtime program. In one embodiment, a received request includes an address with version and runtime information. The version and runtime information are mapped to a destination address that is sent to execute the specified runtime version. In another embodiment, a version control system deploys executable code before the runtime version is executed.

In one embodiment, the present disclosure includes a computer-implemented method comprising receiving, by at least one computer, a first request from a browser, wherein first the request comprises a logical address, the logical address specifying a target runtime program to be executed from a plurality of target runtime programs and a particular version of the target runtime program from a plurality of versions of the target runtime program, accessing, by the at least one computer, based on the logical address, a particular mapping to generate a physical address for the particular version of the target runtime program, said particular mapping being accessed from a plurality of mappings that generate different physical addresses for a plurality of different target runtime programs and a plurality of different versions of the different runtime programs based on different received logical addresses, mapping, by the at least one computer, the particular version of the target runtime program from the logical address to the physical address using said particular mapping, and sending, by the at least one computer, a second request to execute the particular version of the target runtime program using said physical address.

In one embodiment, the method further comprises directing, in response to the first request, a version control system to deploy the particular version of the target runtime and determining that the particular version has been deployed before sending the second request to execute the particular version of the target runtime program.

In one embodiment, the receiving, accessing, mapping, and sending are performed by a reverse proxy.

In one embodiment, the logical address further specifies a particular configuration of the particular version of the target runtime program to be executed from a plurality of configurations of the particular version of the target runtime program, and wherein mapping the particular version of the target runtime program further comprises mapping the first configuration reference from the logical address to the physical address using said particular mapping.

In one embodiment, the logical address comprises a first uniform resource locater (URL) and the physical address comprises a second URL, and wherein the first URL comprises a second level domain and the second URL comprises an internet protocol address, and wherein the target runtime program and the particular version of the target runtime program are specified within the first URL immediately to the left of the second level domain, and wherein the particular mapping specifies the target runtime program and the particular version of the target runtime program to the right of the internet protocol address in the second URL.

In one embodiment, further comprises receiving, by the at least one computer, a third request from a second browser wherein the third request comprises a second logical address specifying the target runtime program to be executed from the plurality of target runtime programs and a second particular version of the target runtime program from a plurality of versions of the target runtime program, accessing, by the at least one computer, based on the second logical address, a second particular mapping to generate a second physical address for the second particular version of the target runtime program, said second particular mapping being accessed from the plurality of mappings that generate different physical addresses for the plurality of different target runtime programs and the plurality of different versions of the different runtime programs based on different received logical addresses, mapping, by the at least one computer, the second particular version of the target runtime program from the second logical address to the second physical address using the second particular mapping, and sending, by the at least one computer, a fourth request to execute the second particular version of the target runtime program using said second physical address.

In one embodiment, the second request to execute the particular version of the target runtime program and the fourth request to execute the second particular version of the target runtime program are sent such that the particular version and the second particular version of the target runtime program execute at least in part at the same time.

In other embodiments the techniques described herein may be realized as methods, or programs on non-transitory computer readable storage mediums, or as systems including at least one computer (e.g., a server computer), one or more processors and a memory or other computer readable storage medium having stored thereon one or more programs, which when executed by the at least one computer, cause the at least one computer to perform the techniques described herein.

For example, in another embodiment the present disclosure includes a non-transitory computer readable storage medium storing one or more programs, the one or more programs comprising instructions for receiving, by at least one computer, a first request from a browser, wherein the first request comprises a logical address, the logical address specifying a target runtime program to be executed from a plurality of target runtime programs and a particular version of the target runtime program from a plurality of versions of the target runtime program, wherein the logical address is a first URL comprising a particular second level domain reference, wherein the target runtime program is specified in a first portion of the first URL to the left of the particular second level domain reference, and wherein the particular version of the target runtime program is specified in a second portion of the first URL to the left of the particular second level domain reference, accessing, by the at least one computer, based on the logical address, a particular mapping to generate a physical address for the particular version of the target runtime program, said particular mapping being accessed from a plurality of mappings that generate different physical addresses for a plurality of different target runtime programs and a plurality of different versions of the different target runtime programs based on different received logical addresses, mapping, by the at least one computer, the target runtime program to be executed and the particular version of the target runtime program from the logical address to the physical address using said particular mapping, wherein the physical address is a second URL comprising an internet protocol address corresponding to the particular second level domain reference, wherein the target runtime program is specified in a first portion of the second URL to the right of the internet protocol address, and wherein the particular version of the target runtime program is specified in a second portion of the second URL to the right of the internet protocol address, and sending, by the at least one computer, a second request to execute the particular version of the target runtime program using said physical address.

The following detailed description and accompanying drawings provide a better understanding of the nature and advantages of the claimed subject matter.

### BRIEF DESCRIPTION OF THE DRAWINGS

FIG. 1 illustrates a runtime version access infrastructure according to an embodiment.

FIG. 2A illustrates a mapping of a logical address to a physical address according to an embodiment.

FIG. 2B illustrates a mapping of a logical address to a physical address according to another embodiment.

FIG. 3 illustrates a method for a runtime version access infrastructure according to an embodiment.

FIG. 4 illustrates a runtime version access infrastructure according to an embodiment.

FIG. 5 illustrates a runtime version access infrastructure according to an embodiment.

FIG. 6 illustrates a method for a runtime version access infrastructure according to an embodiment.

FIG. 7 illustrates hardware of a special purpose computing machine configured with a process according to an embodiment.

### DETAILED DESCRIPTION

Described herein are techniques for a runtime version access infrastructure. In the following description, for purposes of explanation, numerous examples and specific details are set forth in order to provide a thorough understanding of the embodiments. It will be evident, however, to one skilled in the art that the subject matter as defined by the claims may include some or all of the features in these examples alone or in combination with other features described below, and may further include modifications and equivalents of the features and concepts described herein.

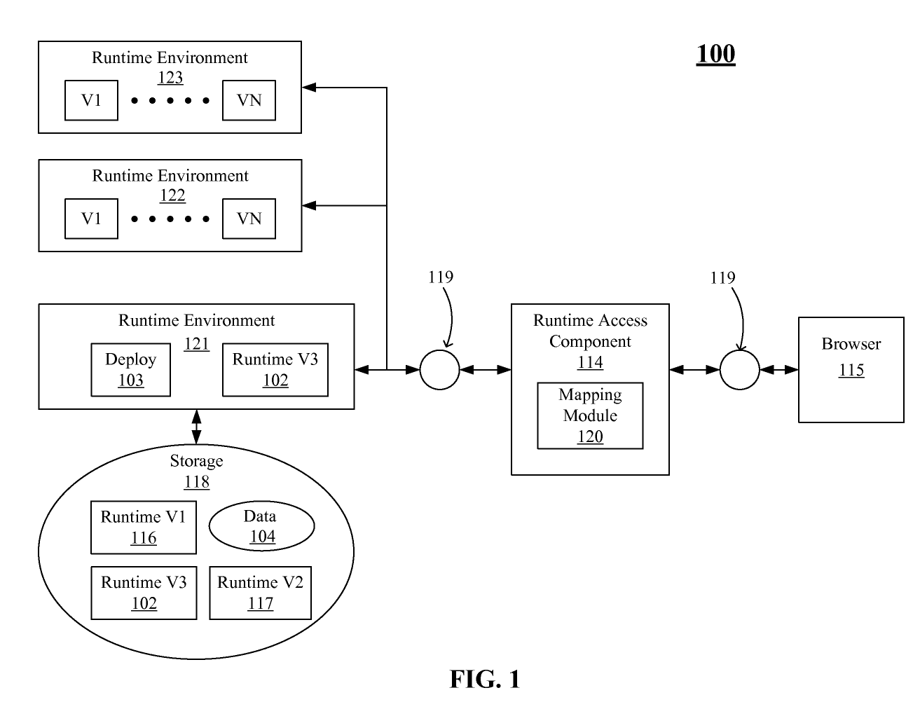

FIG. 1 illustrates a runtime version access infrastructure 100 according to an embodiment. Features and advantages of the present disclosure may include supporting access and execution of multiple different versions of particular programs across multiple different runtime environments. A runtime environment (“runtime program” or just “runtime”) typically includes a configuration of installed software modules to execute a particular program on one or more computers (e.g., servers). As illustrated by the example implementation in FIG. 1, multiple different runtimes 121-123 may be seamlessly accessed (e.g., via a browser 115). Further, different runtimes may have multiple different versions (e.g., V1 . . . VN). Embodiments of the present disclosure may allow different specified versions of a particular runtime to be executed. For example, in FIG. 1, runtimes 121-123, a runtime access component 114, and a browser 115 are connected via a network 119 (e.g., the Internet). Each runtime may include multiple versions (e.g., V1, V2, . . . , VN). A user may invoke a particular version of a particular runtime for execution using browser 115, for example. In this example, a browser 115 may generate a request to runtime access component 114. Runtime access component 114 may receive the request and determine a particular version of a particular runtime from the request and send a request to execute the runtime version specified by the received request to the proper destination.

In this example, runtime 121 may store different runtime versions and data in a storage system 118. FIG. 1 illustrates runtime versions V1 116, V2 117, and V3 102 along with data 104 in storage 118. Data 104 may be program data (e.g., data sets, databases, tables) used by one or more of the runtime versions, for example. Runtime 121 may include a deployment module (“deploy”) 103 for accessing and executing particular runtime versions specified in a request from runtime access component 114, for example. In this example, runtime version V3 102 has been accessed from storage 118 and invoked for execution by deployment module 103. Runtime environment 121 may also access and execute versions V2 or V3 as described in more detail below.

Runtime environments for particular programs, and particular versions of such programs, may be implemented across one or more hardware or virtual server computers, for example. In the example shown in FIG. 1, one example runtime environment may be an execution environment for SAP's HANA. Different runtime environments 121-123 may correspond to different installations of the same program (e.g., HANA) or different installations of different programs (e.g., one for HANA and another for SAP's Gateway). Requests for executing particular versions of particular target runtime programs are forwarded from runtime access component 114 to particular destinations using addresses as described in more detail below.

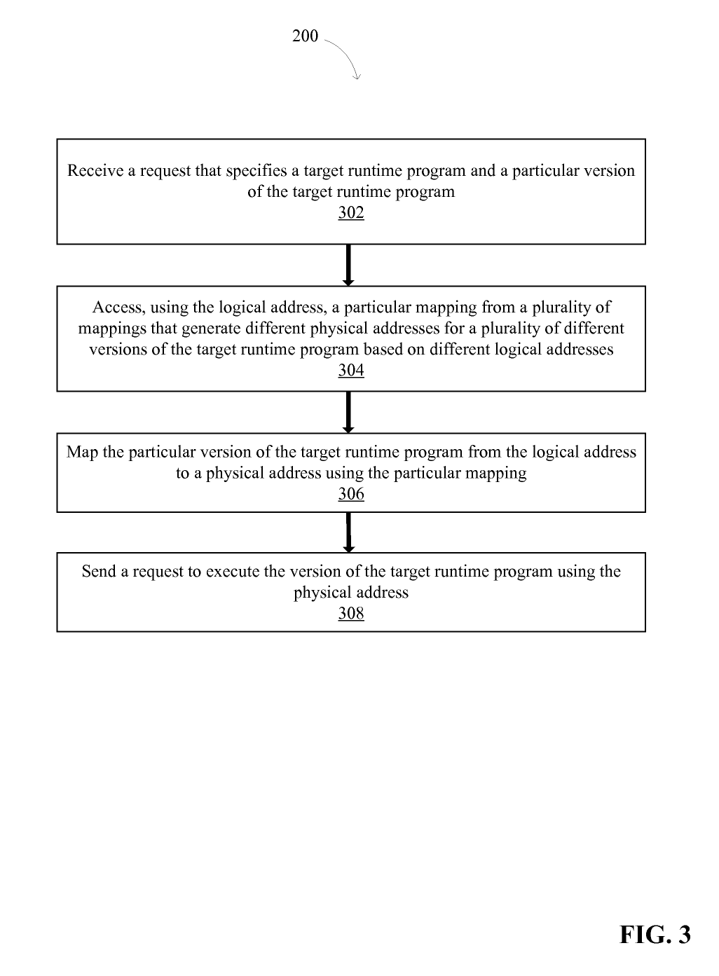

According to the example embodiment in FIG. 1, browser 115 may request access to a version of a target runtime with a request that specifies the target runtime and the version of that runtime (“target runtime version”). For example, a request received by runtime access component 114 may specify runtime 121 and one version out of V1 116, V2 117, or V3 102. The received request may include an initial address specifying a particular version of a particular runtime, for example. Some embodiments of the present disclosure may convert the initial address into a final address specifying a destination for executing the particular version of the particular runtime. The initial address may be a first uniform resource locater (URL) received in runtime access component, and the final address may be a second URL produced by runtime access component and used as a destination of an execution request, for example. In one embodiment, a request received by runtime access component 114 includes a logical address specifying a target runtime program (e.g., runtime 121) to be executed from a plurality of target runtime programs (e.g., runtimes 121-123) and a particular version of the target runtime program (e.g., V3) from a plurality of versions of the target runtime program (e.g., V1-V3). In this example, the logical address may be mapped to a physical address that may be used to access a specific version of a specific target runtime. A particular example of mapping a logical address to a physical address is shown in more detail in FIGS. 3A and 3B below.

In FIG. 1, runtime access component 114 may interpret the logical address in the request and determine the physical address for the target runtime version. Runtime access component 114 then converts the received request to generate an execution request to the physical address of the target runtime version. Runtime access component 114 may include a mapping module 120. Mapping module 120 may include information for mapping target runtime and version information in an address in a received request to a destination address for executing a particular target runtime version. For example, mapping module 120 may include configuration information and/or executable code for performing the mapping operations. Mapping module 120 is shown in FIG. 1 as part of the runtime access component 114, however mapping module 120 may also be implemented as one or more separate components accessed by runtime access component 114, for example.

With some embodiments of runtime access component 114 being able to receive a request including a logical address and then re-write that request to direct the request to a particular target runtime version, runtime access component 114 may provide for accessing multiple versions of a target runtime simultaneously. For example, in FIG. 1, runtime access component 114 could receive, map, and re-write requests from browser 115 to access to any of the runtime versions, V1 116, V2 117, or V3 102. Deployment component 103 may then deploy an instance of (or “instantiate”) the requested runtime version.

An aspect of one example embodiment is that the typical user is unaware of runtime access component 114. For example, in one implementation runtime access component 114 may operate as a reverse proxy, so both user and browser are unaware of runtime access component 114, mapping module 120, or the mapping of the logical address to the physical address. According to one particular embodiment, a request by the browser to access a specific version of the target runtime program will be directed to runtime access component 114 without further input from the browser. For example, a link among listings in a portal may, upon being selected, direct a request to runtime access component 114, which converts the logical address within the request to a physical address according to a mapping and transmits the converted request to the target runtime version within runtime environment 121. Thus, with runtime access component 114 being transparent to the user, a request from browser 115 may appear to get a response directly from the target runtime version.

An additional aspect of one example embodiment is that browser 115 and a user manipulating browser 115 are unaware what version of a target runtime the browser is requesting. They are version unaware because the logical address, which specifies the target runtime and particular version, is accessed via an active link, active button, etc., in the browser that the user has chosen. For example, a user may be presented with a set of links (e.g., as in a portal, or a link among the options of a pull-down menu) for invoking a particular version of a runtime. However, the user will be unaware of the version of the runtime to which the link connects. In most cases, for typical users, being version unaware is preferable because it removes a level of complexity, improving the user experience. However, a certain group of users, such as developers, may benefit from the ability to choose a runtime version. In one embodiment, browser 115 may access a runtime access component frontend (or “frontend”). With the frontend, a user may query runtime access component 114 and determine what runtimes and what versions of those runtimes are contained within mapping module 120. Also, the user may also be able to view or edit mappings within mapping module 120, or add mappings thereto. Such abilities may be contingent on a grant of access rights.

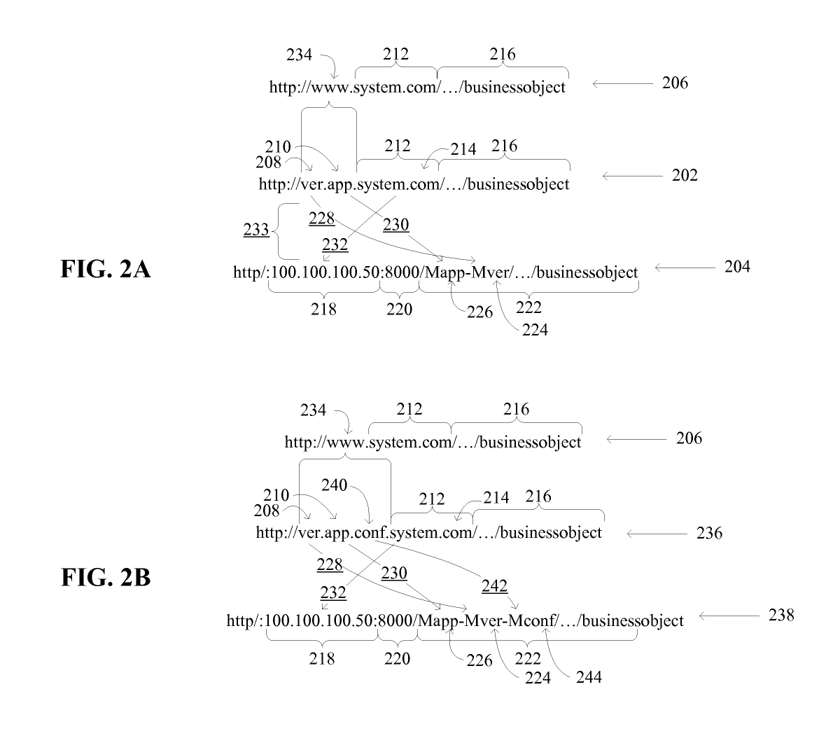

FIG. 2A illustrates one example mapping 200 of a logical address 202 to a physical address 204 according to an embodiment. In FIG. 2A, a logical address 202 is a hypothetical

URL “http://ver.app.system.com/ . . . /businessobject” presented for illustrative purposes. Within logical address 202 the “ver” position is a version specifier 208, the “app” position is a runtime specifier 210, “system.com” is a subdomain 212 (sometimes referred to as a “domain name” or “second level domain”) of “.com” (a top-level domain 214), and “/ . . . /businessobject” is a path 216, with “businessobject” representing the desired function, database, etc., to be accessed. Within logical address 202, version specifier 208 and runtime specifier 210 occupy the position typically occupied by “www” that precedes subdomain 212 in a typical address 206. “Www” may be replaced because it typically does not add to the information provided by subdomain 212.

Physical address 204 is a hypothetical URL “http/:100.100.100.50:8000/app-ver/businessobject” presented for illustrative purposes. Within physical address 204 the “100.100.100.50” position is an internet protocol address (IP address) 218 giving the physical location of the device the request seeks to access, “:8000” is a port 220 at IP address 218, and “/app-ver/ . . . /businessobject” is a mapped path 222. Within mapped path 222 is “Mapp-Mver,” which includes a mapped version specifier 224 (“Mapp”) and a mapped runtime specifier 226 (“Myer”). Mapped version specifier 224 represents version specifier 208 after version specifier 208 is mapped and re-written 228 by runtime access component 114 and mapping module 120. Mapped runtime specifier 226 represents runtime specifier 210 after being similarly mapped and re-written 230. And IP address 218 represents the physical location of subdomain 212 after being re-written 232. Thus, after mappings 228, 230, and 232, mapped runtime specifier 226 and mapped version specifier 224 have become part of mapped path 222. Another aspect of mappings 228 and 230 is that the mapping may include changes in the how both the “app” and “ver” are specified, i.e., the mapping protocol. For example, runtime specifier 210 may be alphabetic and mapped runtime specifier 226 may be numeric. So long as the correct physical address 204 is accessible to runtime access component 114 (e.g., via mapping module 120) based on logical address 202, runtime access component 114 will be able to accurately convert a logical address into a physical address. In one embodiment, an additional aspect of the mapping is that the protocol for mapping from logical address 202 to physical address 204 will vary depending on subdomain 212 and the runtime specified. That is, mapped version specifier 224 and mapped runtime specifier 226 may be anywhere within path 222 following port 220. Additionally, specifiers 224 and 226 may be concatenated, separated differently, reversed in order, or otherwise changed.

In some embodiments, mapping 228 may not correctly map version specifier 208 to mapped version specifier 224 for every subdomain 212 and runtime specified by runtime specifier 210. For example, mapping 228 may vary depending on runtime specifier 210 and subdomain 212. Mapping 230 may also vary with version specifier 208 and subdomain 212. Therefore, mappings 228, 230, and 232 must be used as a set to map logical address 202 to physical address 204. Accordingly, mapping logical address 202 to physical address 204 may use mappings 228, 230, and 232 together as a set of mappings, or a mapping function 233. Mapping function 233 for a particular conversion may be contained in mapping module 120 along with other such mapping functions, for example.

FIG. 2B illustrates a mapping 200 of a logical address 236 to a physical address 238 according to an embodiment. The discussion of FIG. 2A, above, also applies to FIG. 2B with the following additions. To allow access to target runtime versions with multiple configurations, logical address 236 may include a configuration specifier 240 (“conf”). Configuration specifier 240 specifies a particular configuration of the version of the runtime specified by version specifier 208 and runtime specifier 210. As with version specifier 208 and runtime specifier 210, configuration specifier 240 is mapped by runtime access component 114 and mapping module 120 to a physical address 238. Mapped configuration 244 (“Mconf”) represents configuration specifier 240 after being similarly mapped 242. Applications using configuration mapping 244 may allow different users to invoke different configurations of the same version of the same target program. For example, using configuration mapping, one user may seamlessly invoke a program version in a released (or production) configuration while another user (e.g., a tester) may invoke the same program version in a development configuration (e.g., for testing, etc . . . ).

FIG. 3 illustrates a method 300 for a runtime version access infrastructure according to an embodiment. At 302, runtime access component 114 (FIG. 1) receives a request (e.g., from a browser) that specifies a target runtime program and a particular version of the target runtime program. In one example embodiment, the target runtime and version may be specified in a logical address (e.g., a URL). At 304, runtime access component 114 (FIG. 1) accesses a particular mapping from a plurality of mappings within mapping module 120. Mapping module 120 may generate different physical addresses for different versions of the target runtime program based on the different logical addresses that may be received in the request. At 306, runtime access component 114 maps the particular version of the target runtime program from the logical address to a physical address using the particular mapping. At 308, runtime access component 114 sends a request to target runtime environment 121 to execute the version of the target runtime program using the physical address. Thus, the embodiment may direct the request to the correct version of target runtime 102, e.g., V1 116, V2 117, or V3 102, all of which may be deployed within runtime environment 121.

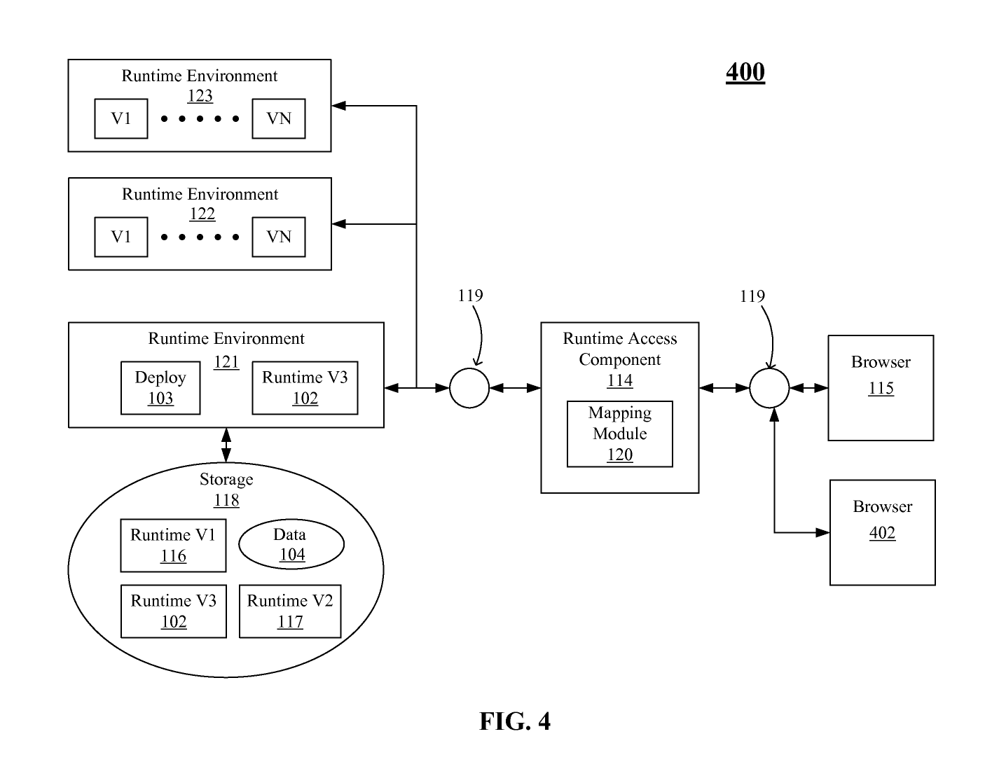

FIG. 4 illustrates a runtime version access infrastructure 400 according to an embodiment. FIG. 4 builds on the description of FIG. 1, which remains applicable. In FIG. 4, runtime environment 101 now includes a second browser 402 connected to runtime access component 114 and runtime environment 121 via network 119. Both browsers 115 and 402 may request access to specific runtime versions through runtime access component 114; and both browsers 115 and 402 may request access to the same or different versions of the same target runtime. To illustrate, should browser 115 request access to target runtime V2 117, runtime access component 114 will receive the request convert the logical address within the request according to a particular mapping. Runtime access component 114 will then transmit the re-written request to the physical address of runtime V2 117. Deployment component 103 will then deploy an instance of runtime V2 117 to respond to the request from browser 115. During the pendency of the request from browser 115, browser 402 may request access to target runtime V1 116, V2 117, or V3 102. Should browser 402 request access to target runtime V2 117, i.e., the same version as in the request from browser 115, runtime access component 114 and mapping module 120 will follow the procedure described regarding the request from browser 115. Deployment module 103 will then deploy another instance of runtime V2 117 to respond to the request from browser 402. Should browser 402 request access to target runtime V3 102, i.e., a different version from that in the request from browser 115, runtime access component 114 and mapping module 120 will follow the procedure described regarding the request from browser 115. Deployment module 103 will then deploy another instance of runtime V3 102 to respond to the request from browser 402.

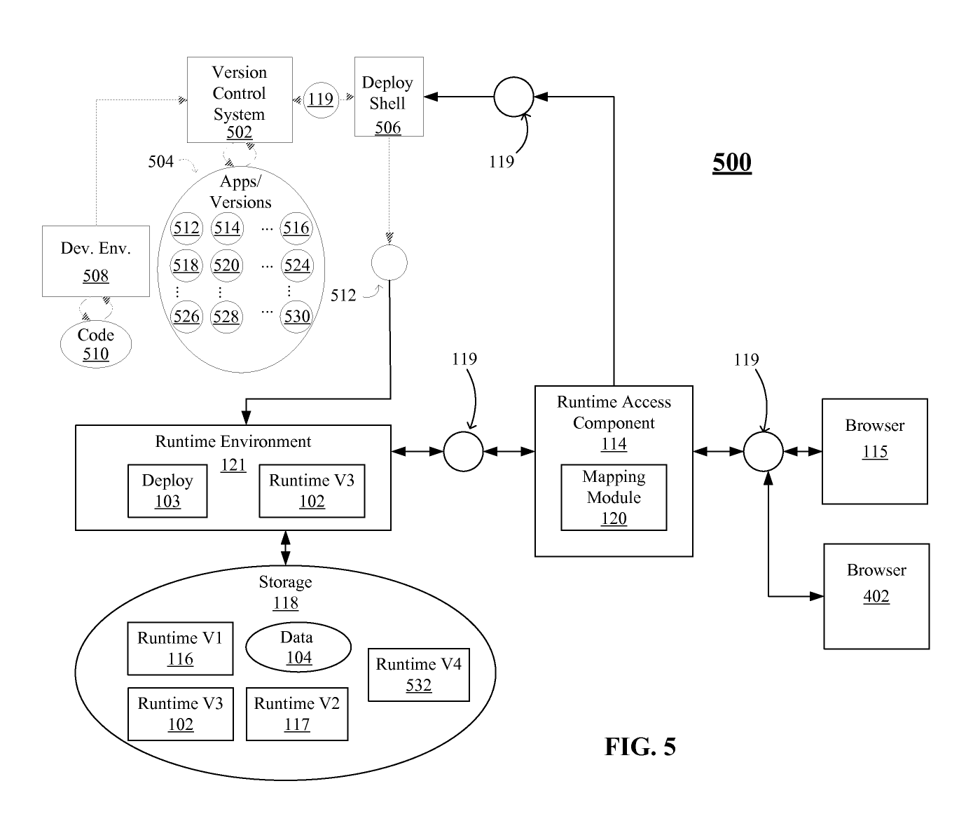

FIG. 5 illustrates a runtime version access infrastructure 500 according to an embodiment. In FIG. 5, browsers 115 and 402, runtime access component 114, mapping module 120, and runtime environment 121 function and communicate as previously described. In addition, runtime access component 114 and runtime environment 121 communicate with a deployment shell 506 (“deploy shell”), which in turn may communicate with a version control system 502 to deploy code in version control system 502 to a particular runtime environment, for example. Version control system 502 is in communications with a version repository 504 and a development environment 508. Version repository 504 is a repository for codes 512, 514, 518, . . . , 530, each of which represents the code for a different runtime version.

Version repository 504 is accessible by version control system 502. And, version control system 502 is in communication with deploy shell 506. Deploy shell may request that version control system 502 provide deploy shell 506 with a particular version of a target runtime program, e.g., runtime version 4, which is contained within repository 504 as code 530. Upon receiving a copy of code 530, deploy shell 506 may provide runtime environment 121 with code 530 via an application programming interface 512, for example. Code 530 is depicted within runtime environment 121 as runtime version 4 (V4) 532. Thus, with version control system 502, and version repository 504, deploy shell 506 may provide runtime environment 121 with new runtimes.

As previously stated, runtime access component 114 is in communication with deploy shell 506. According to one example embodiment, runtime access component 114 may request that deploy shell 506 request code from version control system 502 as part of a process for executing a particular version of a particular runtime triggered by a request. Thus, by being in communication with deploy shell 506, runtime access component 114 may direct that runtime environment 121 be provided with new code for a runtime. Additional capabilities of runtime access component 114 include: the ability to determine, in collaboration with mapping module 120, whether a particular target runtime version resides within runtime environment 121; and the ability to delay sending a request to runtime environment 121 until a particular version of the target runtime is released by deploy shell 506. Thus, runtime access component 114 may delay a request until it has verified that the target runtime version is available within runtime time environment 121. For example, when runtime access component 114 receives a request specifying a particular version of a particular target runtime, a deployment request may be generated to deploy shell 506. The deployment request may instruct deploy shell 506 to access version control system 502 and deploy the latest revision, for example, of the particular version of the target runtime to runtime environment 121, for example. Runtime access component 114 may wait until it receives an indication that the requested revision is deployed before sending an execution request to runtime environment 121.

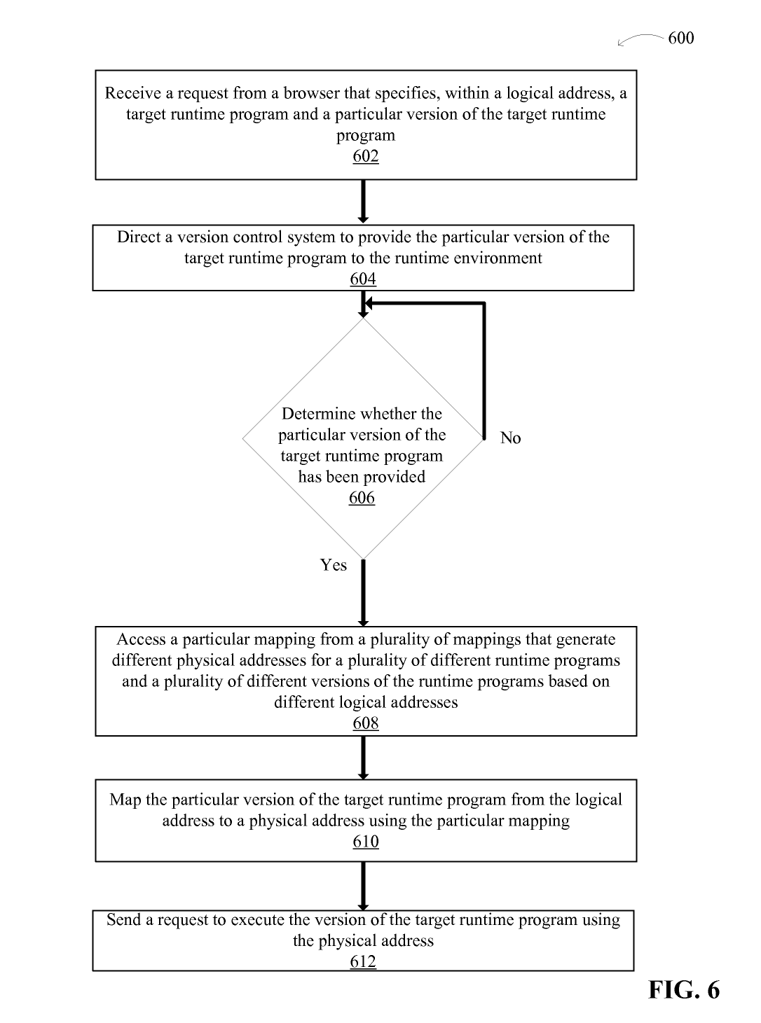

FIG. 6 illustrates a method 600 for a runtime version access infrastructure according to an embodiment. In FIG. 6, runtime access component 114 may delay a request until it has verified that the target runtime version is available. At 602, runtime access component 114 receives a request, e.g., from browser 115, that specifies, within a logical address, a target runtime program and a particular version of the target runtime program. Runtime access component 114 in collaboration with mapping module 120 may then determine that the target runtime program and particular version are not available within runtime environment 121. If so, at 604, runtime access component 114 directs version control system 502 to provide the particular version of the target runtime program to runtime environment 121. At 606, runtime access program 114 waits until it determines that the particular version of the target runtime program has been provided. At 608, runtime access component 114 accesses a particular mapping from a plurality of mappings that generate different physical addresses for a plurality of different runtime programs and a plurality of different versions of the runtime programs based on different logical addresses. At 610, runtime access component 114 maps the particular version of the target runtime program from the logical address to the physical address using the particular mapping. Then at 612, runtime access component 114, sends the request to execute the version of the target runtime program using the physical address.

### Example Hardware

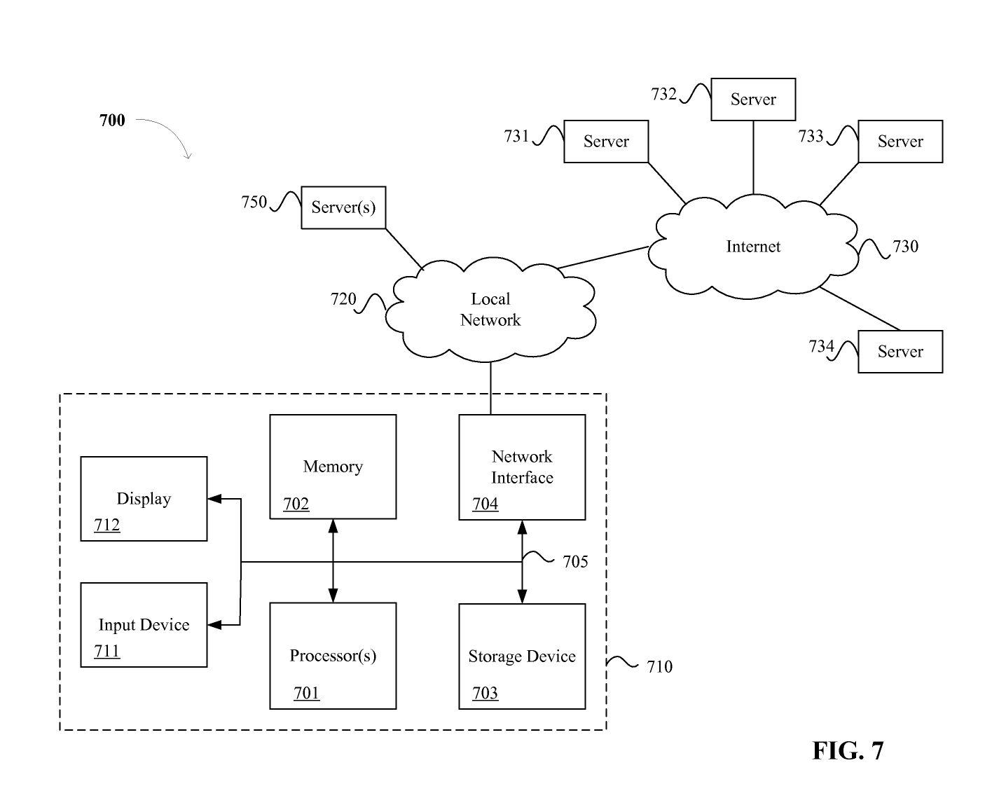

FIG. 7 illustrates hardware of a special purpose computing machine configured with a process according to the above disclosure. The following hardware description is merely one example. It is to be understood that a variety of computers topologies may be used to implement the above described techniques. An example computer system 710 is illustrated in FIG. 7. Computer system 710 includes a bus 705 or other communication mechanism for communicating information, and one or more processor(s) 701 coupled with bus 705 for processing information. Computer system 710 also includes a memory 702 coupled to bus 705 for storing information and instructions to be executed by processor 701, including information and instructions for performing some of the techniques described above, for example. This memory may also be used for storing programs executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 703 may include source code, binary code, or software files for performing the techniques above, for example. Storage device and memory are both examples of non-transitory computer readable storage mediums.

Computer system 710 may be coupled via bus 705 to a display 712 for displaying information to a computer user. An input device 711 such as a keyboard, touchscreen, and/or mouse is coupled to bus 705 for communicating information and command selections from the user to processor 701. The combination of these components allows the user to communicate with the system. In some systems, bus 705 represents multiple specialized buses, for example.

Computer system 710 also includes a network interface 704 coupled with bus 705. Network interface 704 may provide two-way data communication between computer system 710 and a local network 720. The network interface 704 may be a wireless or wired connection, for example. Computer system 710 can send and receive information through the network interface 704 across a local area network, an Intranet, a cellular network, or the Internet, for example. Computer system 710 may be a server in a data center, for example, networked with other servers 750. One example implementation may include a runtime access component executing on a computer system 710 that receives, maps, and sends requests as described above. In the Internet example, a runtime access component, for example, may send requests to execute particular versions of runtimes on other backend systems that may reside on multiple different hardware servers 731-735 across the network, for example. Servers 750 and/or 731-735 and some of the software functions described herein may also reside in a cloud computing environment, for example.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A computer-implemented method comprising:
receiving, by at least one computer, a first request from a browser, wherein first the request comprises a logical address, the logical address specifying a target runtime program to be executed from a plurality of target runtime programs and a particular version of the target runtime program from a plurality of versions of the target runtime program;
accessing, by the at least one computer, based on the logical address, a particular mapping to generate a physical address for the particular version of the target runtime program, said particular mapping being accessed from a plurality of mappings that generate different physical addresses for a plurality of different target runtime programs and a plurality of different versions of the different runtime programs based on different received logical addresses;
mapping, by the at least one computer, the particular version of the target runtime program from the logical address to the physical address using said particular mapping; and
sending, by the at least one computer, a second request to execute the particular version of the target runtime program using said physical address.

2. The computer-implemented method of claim 1, further comprising:
directing, in response to the first request, a version control system to deploy the particular version of the target runtime; and
determining that the particular version has been deployed before sending the second request to execute the particular version of the target runtime program.

3. The computer-implemented method of claim 1, wherein the receiving, accessing, mapping, and sending are performed by a reverse proxy.

4. The computer-implemented method of claim 1, the logical address further specifying a particular configuration of the particular version of the target runtime program to be executed from a plurality of configurations of the particular version of the target runtime program, and wherein mapping the particular version of the target runtime program further comprises mapping the first configuration reference from the logical address to the physical address using said particular mapping.

5. The computer-implemented method of claim 1, wherein the logical address comprises a first uniform resource locater (URL) and the physical address comprises a second URL, and wherein the first URL comprises a second level domain and the second URL comprises an internet protocol address, and wherein the target runtime program and the particular version of the target runtime program are specified within the first URL immediately to the left of the second level domain, and wherein the particular mapping specifies the target runtime program and the particular version of the target runtime program to the right of the internet protocol address in the second URL.

6. The computer-implemented method of claim 1, further comprising:
receiving, by the at least one computer, a third request from a second browser wherein the third request comprises a second logical address specifying the target runtime program to be executed from the plurality of target runtime programs and a second particular version of the target runtime program from a plurality of versions of the target runtime program;
accessing, by the at least one computer, based on the second logical address, a second particular mapping to generate a second physical address for the second particular version of the target runtime program, said second particular mapping being accessed from the plurality of mappings that generate different physical addresses for the plurality of different target runtime programs and the plurality of different versions of the different runtime programs based on different received logical addresses;
mapping, by the at least one computer, the second particular version of the target runtime program from the second logical address to the second physical address using the second particular mapping; and
sending, by the at least one computer, a fourth request to execute the second particular version of the target runtime program using said second physical address.

7. The computer-implemented method of claim 6, wherein the second request to execute the particular version of the target runtime program and the fourth request to execute the second particular version of the target runtime program are sent such that the particular version and the second particular version of the target runtime program execute at least in part at the same time.

8. A non-transitory computer readable storage medium storing one or more programs, the one or more programs comprising instructions for:
receiving, by at least one computer, a first request from a browser, wherein the first request comprises a logical address, the logical address specifying a target runtime program to be executed from a plurality of target runtime programs and a particular version of the target runtime program from a plurality of versions of the target runtime program, wherein the logical address is a first URL comprising a particular second level domain reference, wherein the target runtime program is specified in a first portion of the first URL to the left of the particular second level domain reference, and wherein the particular version of the target runtime program is specified in a second portion of the first URL to the left of the particular second level domain reference;
accessing, by the at least one computer, based on the logical address, a particular mapping to generate a physical address for the particular version of the target runtime program, said particular mapping being accessed from a plurality of mappings that generate different physical addresses for a plurality of different target runtime programs and a plurality of different versions of the different target runtime programs based on different received logical addresses;
mapping, by the at least one computer, the target runtime program to be executed and the particular version of the target runtime program from the logical address to the physical address using said particular mapping, wherein the physical address is a second URL comprising an internet protocol address corresponding to the particular second level domain reference, wherein the target runtime program is specified in a first portion of the second URL to the right of the internet protocol address, and wherein the particular version of the target runtime program is specified in a second portion of the second URL to the right of the internet protocol address; and
sending, by the at least one computer, a second request to execute the particular version of the target runtime program using said physical address.

9. The non-transitory computer readable storage medium of claim 8, further comprising instructions for:
directing a version control system to deploy the particular version of the target runtime; and
determining that the particular version has been deployed before sending the second request to execute the particular version of the target runtime program.

10. The non-transitory computer readable storage medium of claim 8, wherein the instructions for receiving, accessing, mapping, and sending are directed to a reverse proxy.

11. The non-transitory computer readable storage medium of claim 8, the logical address further specifying a particular configuration of the particular version of the target runtime program to be executed from a plurality of configurations of the particular version of the target runtime program, and wherein mapping the particular version of the target runtime program further comprises mapping the first configuration reference from the logical address to the physical address using said particular mapping.

12. The non-transitory computer readable storage medium of claim 8, further comprising instructions for:
receiving, by the at least one computer, a third request from a second browser wherein the third request comprises a second logical address specifying the target runtime program to be executed from the plurality of target runtime programs and a second particular version of the target runtime program from a plurality of versions of the target runtime program, and wherein the second logical address is a third URL comprising the particular second level domain reference, wherein the target runtime program is specified in a first portion of the third URL to the left of the particular second level domain reference, and wherein the second particular version of the target runtime program is specified in a second portion of the third URL to the left of the particular second level domain reference;
accessing, by the at least one computer, based on the second logical address, a second particular mapping to generate a second physical address for the second particular version of the target runtime program, said second particular mapping being accessed from the plurality of mappings that generate different physical addresses for the plurality of different target runtime programs and the plurality of different versions of the different runtime programs based on different received logical addresses;
mapping, by the at least one computer, the target runtime program to be executed and the second particular version of the target runtime program from the second logical address to the second physical address using said second particular mapping, wherein the second physical address is a fourth URL comprising a second internet protocol address corresponding to the particular second level domain reference, wherein the target runtime program is specified in a first portion of the second URL physical address to the right of the second internet protocol address, and wherein the second particular version of the target runtime program is specified in a second portion of the fourth URL to the right of the second internet protocol address; and
sending, by the at least one computer, a fourth request to execute the second particular version of the target runtime program using said second physical address.

13. The non-transitory computer readable storage medium of claim 12, wherein the first internet protocol address and the second internet protocol address are the same.

14. The non-transitory computer readable storage medium of claim 12, wherein the second request to execute the particular version of the target runtime program and the fourth request to execute the second particular version of the target runtime program are sent such that the particular version and the second particular version of the target runtime program execute at least in part at the same time.

15. A system comprising:
at least one computer; and
a non-transitory computer readable medium having stored thereon one or more programs, which when executed by the at least one computer, cause the at least one computer to:
receive, by the at least one computer, a first request from a browser, wherein the first request comprises a logical address, the logical address specifying a target runtime program to be executed from a plurality of target runtime programs and a particular version of the target runtime program from a plurality of versions of the target runtime program;
access, by the at least one computer based on the logical address, a particular mapping to generate a physical address for the particular version of the target runtime program, said particular mapping being accessed from a plurality of mappings that generate different physical addresses for a plurality of different target runtime programs and a plurality of different versions of the different runtime programs based on different received logical addresses;
map, by the at least one computer, the particular version of the target runtime program from the logical address to the physical address using said particular mapping;
send, by the at least one computer, a second request to execute the particular version of the target runtime program using said physical address.

16. The system of claim 15, wherein the one or more programs further cause the at least one computer to:
direct a version control system to deploy the particular version of the target runtime; and
determine that the particular version has been deployed before sending the second request to execute the particular version of the target runtime program.

17. The system of claim 15,wherein the receive, access, map, and send steps are performed by a reverse proxy.

18. The system of claim 15, wherein the first request further comprises a first configuration reference, the first configuration address specifying a configuration of the particular version of the target runtime program to be executed from a plurality of configurations of the particular version of the target runtime program, and wherein mapping the particular version of the target runtime program further comprises mapping the first configuration reference from the logical address to the physical address using said particular mapping.

19. The system of claim 15, wherein the logical address comprises a first uniform resource locater (URL) and the physical address comprises a second URL, and wherein the first URL comprises a second level domain and the second URL comprises an internet protocol address, and wherein the target runtime program and the particular version of the target runtime program are specified within the first URL immediately to the left of the second level domain, and wherein the particular mapping specifies the target runtime program and the particular version of the target runtime program to the right of the internet protocol address in the second URL.

20. The system of claim 1, wherein the one or more programs further cause the at least one computer to:
receive, by the at least one computer, a third request from a second browser wherein the third request comprises a second logical address specifying the target runtime program to be executed from the plurality of target runtime programs and a second particular version of the target runtime program from a plurality of versions of the target runtime program;
access, by the at least one computer, based on the second logical address, a second particular mapping to generate a second physical address for the second particular version of the target runtime program, said second particular mapping being accessed from the plurality of mappings that generate different physical addresses for the plurality of different target runtime programs and the plurality of different versions of the different runtime programs based on different received logical addresses;
map, by the at least one computer, the second particular version of the target runtime program from the second logical address to the second physical address using the second particular mapping; and
send by the at least one computer, a fourth request to execute the second particular version of the target runtime program using said second physical address.
